(19) United States
(12) Patent Application Publication
(10) Pub. No.: US 2011/0152128 A1
(43) Pub. Date: Jun. 23, 2011

(54) ENHANCED MICROPLATE CONFIGURATIONS

(76) Inventors: Mark G. Herrmann, Bountiful, UT (US); Tanya M. Sandrock, Salt Lake City, UT (US)

(21) Appl. No.: 12/903,201

(22) Filed: Oct. 12, 2010

Related U.S. Application Data
(63) Continuation-in-part of application No. 12/902,080, filed on Oct. 11, 2010.
(60) Provisional application No. 61/251,178, filed on Oct. 13, 2009.

(51) Int. Cl. C40B 60/14

(52) U.S. Cl. 506/40

(57) ABSTRACT

An enhanced microplate and retention device for selectively retaining tube inserts within the microplate. A dynamic microplate having a selectable number of interchangeable microwells.

### RELATED APPLICATIONS

The present application is a continuation-in-part of U.S. patent application Ser. No. 12/902,080, entitled ENHANCED MICROPLATE CONFIGURATIONS, filed Oct. 11, 2010, which claims priority to U.S. Provisional Application No. 61/251,178, entitled ENHANCED MICROPLATE CONFIGURATIONS, filed Oct. 13, 2009, both of which applications are incorporated herein in their entirety.

### BACKGROUND OF THE INVENTION

1. Field of the Invention The present invention relates to systems and methods whereby to increase the efficiency and capacity of microplate devices. In particular, the present invention relates to microplate configurations which increase the sample capacity of a microplate while conserving dimensional standards of microplate as set by Society for Biomolecular Screening Society (SBS). The present invention further relates to retention systems whereby to control or preserve the position of a sample tube within a microplate device. Still further, the present invention relates to a system of interchangeable sample well strips, wherein a dynamic microplate frame permits a user to selectively configure the microplate frame to include a desired microwell plate configuration.

2. Background and Related Art

Analytical systems provide a wide variety of tools for researchers and diagnostics. Miniaturization and automation of these analytical systems has allowed for dramatic increases in consistency, reliability and throughput. Among these systems, microplates are frequently used to provide an array of fluid samples to be tested. These microplates are used in a wide variety of equipment from fluid handlers, readers (e.g. fluorescence, fluorescence polarization, absorbance, luminescence), centrifuges, shakers, thermal cyclers, incubators, DNA sequencers, archives, cell and tissue culture, cell harvesters, illuminometer, mixers, radiometric counters, dispenser, washers, spectrometers, dispensers, replicators, evaporators, freezers, heaters, sealers, dryers, imagers, microscopes, photometers, microplate stackers and handlers, and the like.

Typical microplates have a standardized geometry and well configuration as promoted by ANSIISBS 4-2004. As early as the first meeting of the Society for Biomolecular Screening (SBS) in 1995, a need for clearly defined dimensional standards of a microplate was identified. At the time, the microplate was already becoming an essential tool used in drug discovery research. At the time, the concept of a microplate was similar among various manufacturers, but the dimensions of microplates produced by different vendors, and even within a single vendors catalog line varied. This often caused numerous problems when microplates were to be used in automated laboratory instrumentation.

In late 1995, members of the SBS began working on defining dimensional standards for the standard 96 well microplate. The first written proposal was released in December 1995 and presented at numerous scientific conferences and journals throughout 1996. This initial proposed standard was officially presented to the membership of SBS for approval at the annual meeting in October 1996 in Basel, Switzerland. Between then and late 1998, various versions of the proposed standards for 96 and 384 well microplates were circulated to the membership of the society. In early 1999, efforts to begin formalizing the proposed standards in preparation for submission to a recognized standards organization were begun. For several decades the arrangement of wells has been according to a 2:3 matrix of wells, such that the above ANSI publication has officially promoted and recognized these standards. Microplates having 6, 24, 96, 384 and 1536 wells are typical, although 3456 and 9600 well arrangements have also seen some limited use. The 8×12 array microplate is so accepted in the laboratory that when assays are developed little thought is given to the its consequences in most applications. For instance consider an assay where 96 samples or compounds are or can be archived, processed, or presented for analysis. To accommodate the need for standards and controls within the assay the samples are split to multiple plates thus incurring the cost of additional plate, reagents, standards, controls and time.

### SUMMARY OF THE INVENTION

The present invention addresses the inefficiencies present in current approaches to utilizing microplates in diagnostic and micro assays. An enhanced microplate in accordance with the present invention can include a base having a footprint with a length of 127.76 mm±1 mm and a width of 85.48 mm±1 mm. The base can be configured for an array of microwells having a base being configured for an array of microwells such that there are ax rows along the width and ∥bx∥ columns along the length, where a is 8 or 9, b is 12, 13 or 14 provided that when b is 12, a is 9, and x is 0.5 or a positive integer.

A method of using these enhanced microplates can include introducing a plurality of fluid samples into the microwells. The plurality of fluid samples can be treated in accordance with known procedures (e.g. immunoassays, PCR, and the like). Once the treatment is performed, the remaining fluid can be subjected to an appropriate test to measure a desired property from which valuable information can be obtained.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A is a perspective view of an enhanced 8×13 tube rack having 104 wells, in accordance with a representative embodiment of the present invention;

FIG. 1B is a perspective view of a microwell plate having retention means in accordance with a representative embodiment of the present invention;

FIG. 1C is a cross-section side view of a microwell plate having retention means in accordance with a representative embodiment of the present invention;

FIG. 1D is a perspective view of a microwell plate having retention means in accordance with a representative embodiment of the present invention;

FIG. 1E is a cross-section side view of a microwell plate having retention means in accordance with a representative embodiment of the present invention;

FIG. 2 is a perspective view of an enhanced 8×13 microplate having 104 wells and removable strip tube inserts along columns, in accordance with a representative embodiment of the present invention;

FIG. 3 is a perspective view of an enhanced 8×13 microplate having 104 wells, in accordance with a representative embodiment of the present invention;

FIG. 4A is a perspective view of a dynamic microwell plate having a 96-well configuration comprising removable sample well strips, in accordance with a representative embodiment of the present invention;

FIG. 4B is a plan side view of a dynamic microwell plate having a 96-well configuration comprising removable sample well strips, in accordance with a representative embodiment of the present invention;

FIG. 4C is a perspective view of an 8-well sample well strip, in accordance with a representative embodiment of the present invention;

FIG. 4D is a perspective view of a dynamic microwell plate having a 104-well configuration comprising removable sample well strips, in accordance with a representative embodiment of the present invention;

FIG. 4E is a plan side view of a dynamic microwell plate having a 96-well configuration comprising removable sample well strips, in accordance with a representative embodiment of the present invention;

FIG. 4F is a perspective view of a 32-well sample well strip, in accordance with a representative embodiment of the present invention;

FIG. 4G is a perspective view of a 64-well sample well strip, in accordance with a representative embodiment of the present invention;

FIG. 4H is a perspective view of an integral microwell plate having mixed and matched sample wells, in accordance with a representative embodiment of the present invention;

FIG. 5A is a perspective view of a discrete volume reservoir plate, in accordance with a representative embodiment of the present invention;

FIG. 5B is a cross-section view of a discrete volume reservoir plate, in accordance with a representative embodiment of the present invention;

FIG. 6 is a schematic view of a 28 well enhanced microplate, in accordance with a representative embodiment of the present invention;

FIG. 7 is a schematic view of a 104 well enhanced microplate, in accordance with a representative embodiment of the present invention;

FIG. 8 is a schematic view of a 416 well enhanced microplate, in accordance with a representative embodiment of the present invention; and

FIG. 9 is a schematic view of a 1664 well enhanced microplate, in accordance with a representative embodiment of the present invention.

### DETAILED DESCRIPTION OF THE INVENTION

While these representative embodiments are described in sufficient detail to enable those skilled in the art to practice the invention, it should be understood that other embodiments may be realized and that various changes to embodiments of the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

In describing and claiming the present invention, the following terminology will be used:

The singular forms “a”, “an”, and “the” include plural referents unless the context clearly dictates otherwise. Thus, for example, reference to “a well” includes reference to one or more of such features and reference to “treating” refers to one or more such steps.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

### Representative Embodiments

An enhanced microplate can include a base having a footprint with a length of 127.76 mm±1 mm and a width of 85.48 mm±1 mm. The base can be configured for an array of microwells such that there are ax rows along the width and ∥bx∥ columns along the length, wherein a is 8 or 9, b is 12, 13 or 14 provided that when b is 12, a is 9, and x is 0.5 or a positive integer.

Although the range can vary, x is typically 0.5, 1, 2, 4, 6 or 10. In one specific aspect x is 1. However, any integer can be useful, although currently useful embodiments are up to x is 10. Table I provides an outline of the array configurations for the 8:13 configurations for various x values and a comparison with 2:3 arrangements.

TABLE 1

| x | 2:3 Matrix | 2:3 Wells | 8:13 Matrix | 8:13 Wells |
|---|---|---|---|---|
| 0.5 | 4 × 6 | 24 | 4 × 7 | 28 |
| 1 | 8 × 12 | 96 | 8 × 13 | 104 |
| 2 | 16 × 24 | 384 | 16 × 26 | 416 |
| 3 | 24 × 36 | 864 | 24 × 39 | 936 |
| 4 | 32 × 48 | 1536 | 32 × 52 | 1664 |
| 5 | 40 × 60 | 2400 | 40 × 65 | 2600 |
| 6 | 48 × 72 | 3456 | 48 × 78 | 3744 |
| 7 | 56 × 84 | 4704 | 59 × 91 | 5096 |
| 8 | 64 × 96 | 6144 | 64 × 104 | 6657 |
| 9 | 72 × 108 | 7776 | 72 × 117 | 8424 |
| 10 | 80 × 120 | 9600 | 80 × 130 | 10400 |

*Not all of the 2:3 configurations listed above are currently used.

As can be appreciated from Table I each of the 8:13 configurations provides an 8.3% increase in the number of available wells (except for x=0.5 which is a 16.7% increase). Thus, the 8:13 matrix microplates provide an 8.3% increase in absolute throughput for a set number of microplate runs through any given equipment. Further, a can also be 9 such that 9×12, 9×13 and 9×14 matrix arrays can be achieved. For example, in the case of x=1 these 9xb arrays would have 108, 117 and 126 wells respectively. In these cases, the percent increase in throughput relative to the standard 96 well microplate plate goes up (e.g. 12.5%, 21.9% and 31.25%, respectively). These increases do not include process efficiencies realized by avoiding the use of additional microplates for controls and reference samples.

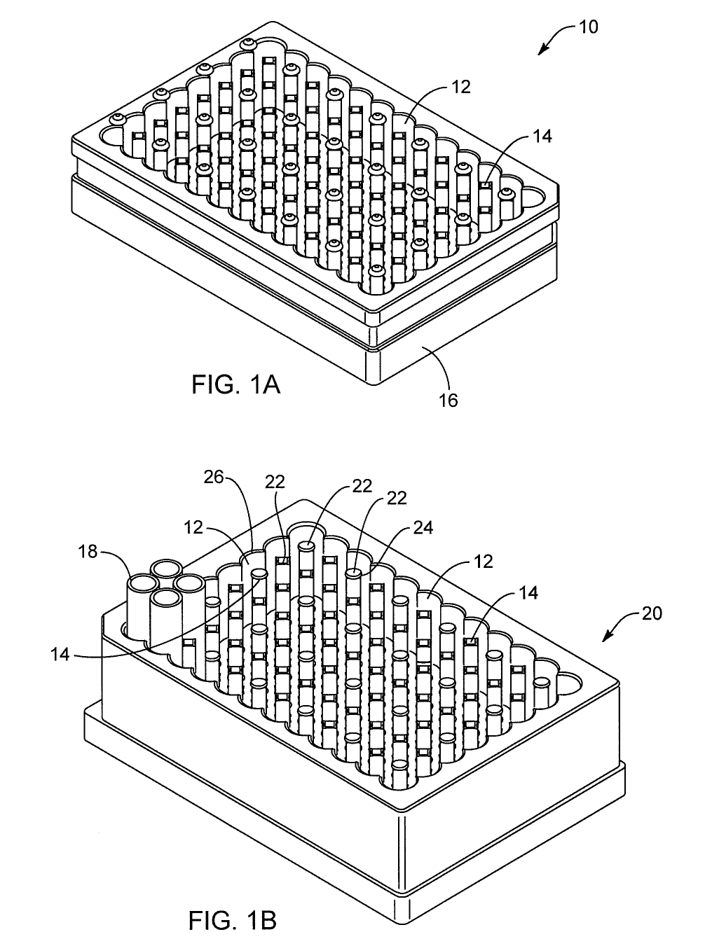

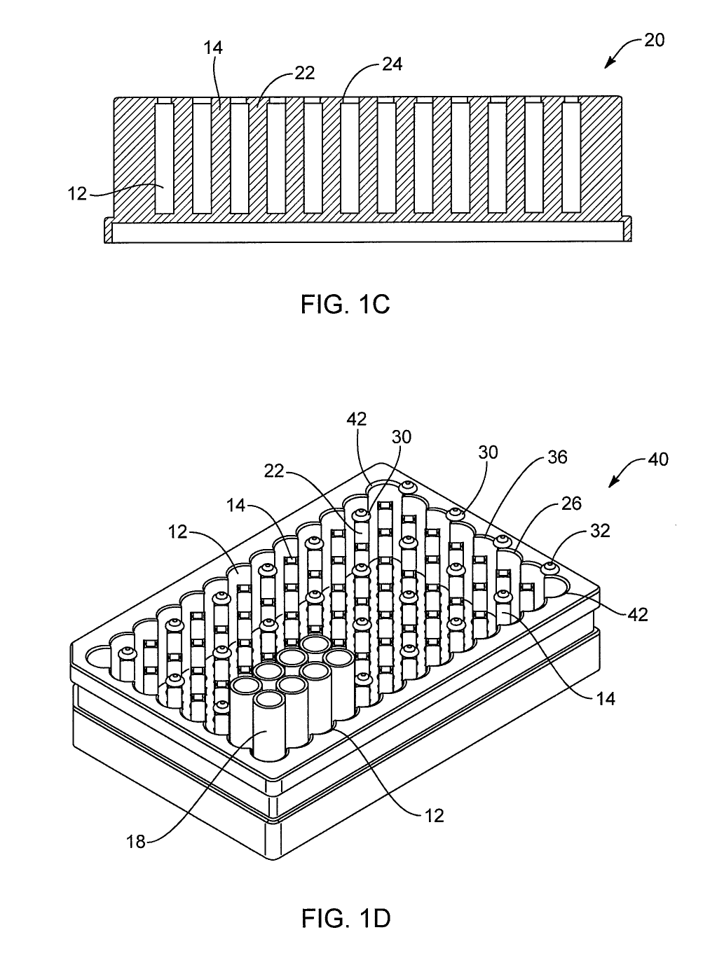

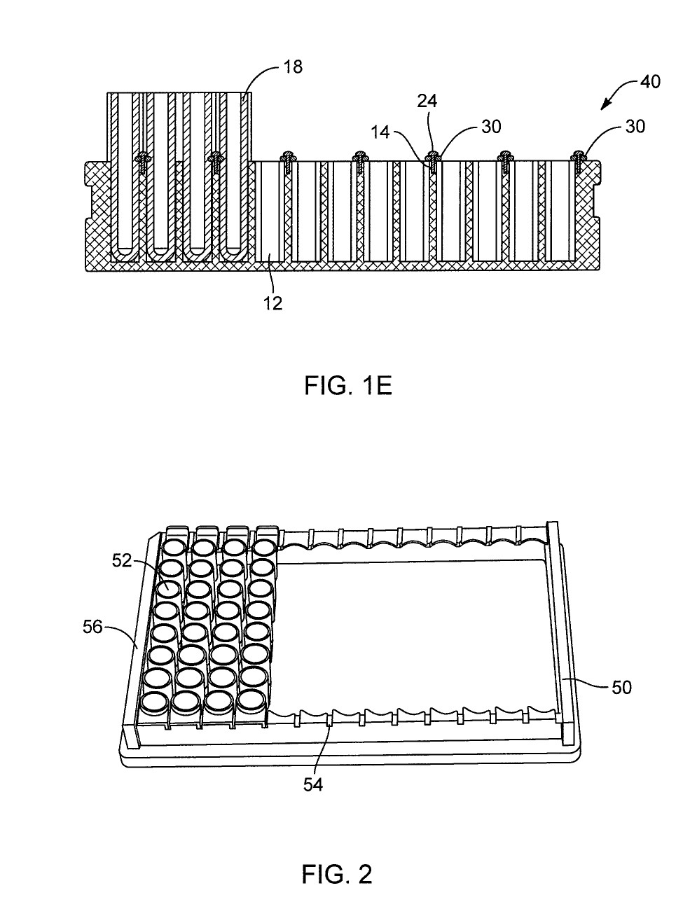

FIG. 1A illustrates a 104-well microplate 10 having microwells recesses 12 configured to hold tube inserts. In this case, the recesses 12 are overlapping so that open areas are interconnected with pillars 14 at intersections between four neighboring tube positions. The array of microwells 12 can be integrated with the base 16 whereby the microwells 12, pillars 14 and base 16 are an integral unit. In some embodiments, microplate 10 comprises a polymer material, such as polypropylene, wherein microplate 10 is formed by injection molding, blow molding, or another form of plastic molding known in the art. In other embodiments, microplate 10 comprises a metallic material, such as aluminum or an aluminum alloy, wherein the metallic material facilitates even distribution of thermal energy throughout the plurality of microwells 12. Still further, in some embodiments microplate 10 comprises a composite material. Thus, one having skill in the art will appreciate that microplate 10 may comprise any material as required by the user to obtain a desired function, cost savings, compatibility, or convenience for a given application.

With reference to FIG. 1B, a 96-well microplate 20 is shown having microwell recesses 12 configured to hold tube inserts 18. In some embodiments, open areas between microwell recesses 12 are interconnected with pillars 14 at intersections between four neighboring tube positions. Further, in some embodiments, a central pillar 22 is positioned at a central position such that the central pillar 22 is surrounded by four neighboring tube positions. As such, each tube insert 18 positioned within a microwell access 12 will be in contact with an adjacent central pillar 22. Thus, the number and position of central pillars 22 largely depends upon the well configuration of the microplate.

For example, where a microplate comprises only 4 microwells, a single central pillar 22 may be provided to establish contact between the central pillar 22 and tube inserts positioned within the adjacent microwells. Additionally, in some embodiments where a microplate comprises 16 microwells, four central pillars 22 will be alternately combined with three additional pillars to provide the 16 microwells into which the tube inserts will be positioned. Thus, in general a microplate will include one centrally positioned pillar 22 per four microwells 12. However, one having skill in the art will appreciate that the number of centrally positioned pillars 22 will vary based on the configuration of the microplate, sized of the centrally positioned pillars 22, as well as the size and spacing of the plate's microwells 12.

With reference to FIGS. 1B and 1C, in some embodiments a tip portion 24 of central pillar 22 is oversized such that the tip portion 22 overlaps a portion of all four neighboring tube position, or microwell recesses 12. Thus, when a tube insert 18 is positioned within a microwell recess 12, the tip portion 24 of the central pillar 22 biases the position of the tube insert 18 against the remaining three pillars 14 (or edge boundary 26 of microplate 20) which, along with the central pillar 22, define the microwell recess 12 into which the tube insert 18 is positioned. The biasing action of the central pillar 22 provides mechanical friction between the tube insert 18 and the microwell recess 12, thereby maintaining the position of the tube insert 18 within the microwell recess 12. In some embodiments, tip portion 24 is coated with a polymer material to increase friction between the central pillar 22 and the tube insert 18, such as a polypropylene or polyurethane coating.

With reference to FIGS. 1D and 1E, a 104-well microplate 40 is shown. In some embodiments tip portion 24 of central pillar 22 is modified to include a retention member 30. In some embodiments, retention member 30 is fixedly coupled to tip portion 24 wherein retention member 30 is wider than central pillar 22 such that a portion of retention member 30 overlaps adjacent microwell recesses 12. Retention member 30 may include any material or structure necessary to impinge upon adjacent microwell recesses 12. For example, in some embodiments retention member 30 comprises a polymer o-ring that is fixedly coupled to tip portion 24 via a fastener, such as a screw (e.g. screw 32), a rivet, or another fastener. As positioned, retention member 30 contacts a portion of tube insert 18 thereby biasing tube insert 18 against adjacent pillars 14 and/or edge boundaries 26.

The biasing function of retention member 30 increases the friction between tube insert 18 and microwell plate 40 thereby preventing unwanted removal of the tube inserts 18 from their respective microwells 12. For example, in some embodiments tube inserts 18 remain securely biased within microwells 12 when plate 40 is inverted, such as when emptying the contents of tube inserts 18 following a measured reading. However, retention member 30 still enables removal of tube inserts 18 as desired by the user. The user simply removes the tube inserts 18 from their respective microwells 12 by lifting the tube inserts 18 with a force greater than the retention force of the retention member 30. In this way, contaminated or otherwise undesirable tube inserts 18 may be removed and replaced as desired.

With further reference to FIGS. 1D and 1E, a retention member 30 is fastened to base 28 at a position interposed between adjacent edge boundaries, for example between edge boundaries 26 and 36, thereby compensating for the odd number of microwells 12 comprising each row of the 104-well plate 40. One of ordinary skill in the art will appreciate that the central position of pillars 22 are sufficiently spaced where the sample plate comprises an even number of microwells 12 per row, such as with plate 20, above. However, where the plate 40 comprises an odd number of columns, additional retention members 30 are fastened to base 28 to provide a biasing function to tube inserts 18 inserted within the additional, or odd column 42.

One of ordinary skill in the art will further appreciate that retention member 30 may be implemented in a wide variety of devices wherein it is desirable to retain an object in a well, slot, or other enclosure configured to receive the object. For example, in some embodiments a retention member 30 is used in combination with a finger rack. In other embodiments a retention member 30 is used in combination with a rack used for holding containers, such as vials, ampoules, jars, cans, tanks, tools, utensils, and the like. In some embodiments, a single retention member 30 is positioned to partially overlap a single well for receiving a single item. As such, the retention member 30 provides an interference fit for the single item within the single well. In other embodiments, a single retention member 30 is position to partially overlap two adjacent wells, each well being provided to receive an item. Further, in some embodiments a single retention member 30 is position to partially overlap a plurality of adjacent wells, wherein each well is configured to receive an item, and wherein the partially overlapped position of the retention member 30 provides a biasing function to retain the item within its respective well.

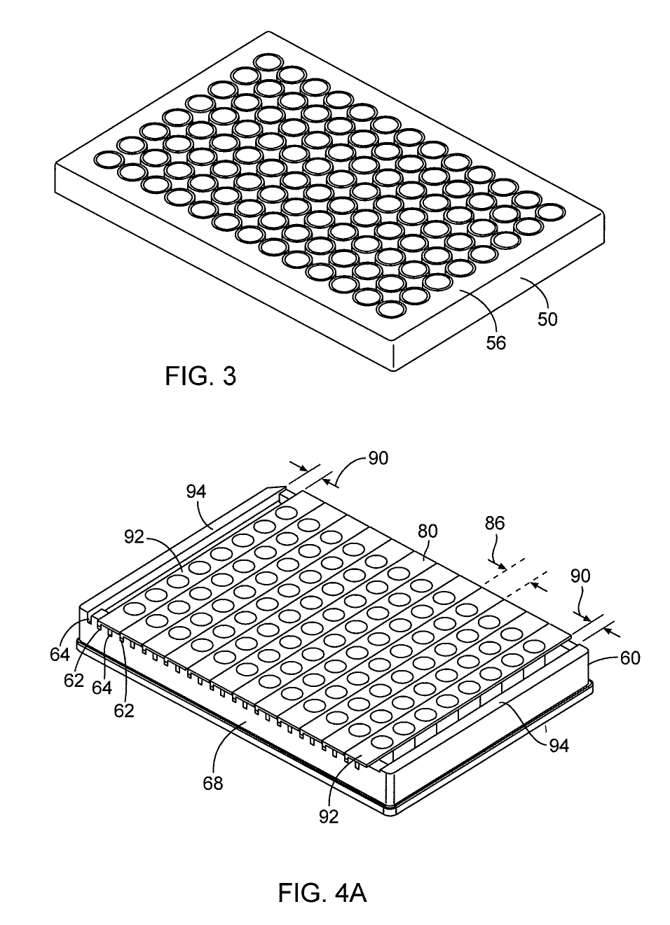

Alternatively, FIG. 2 illustrates a base 50 having removable strip tube holders 52 (shown with a single strip in place). In some embodiments, base 50 includes notched recesses 54 to receive the strip 52 of a column segment having ax microwells therein. Regardless of the upper configuration, base 50 can optionally have a flange 56 which forms the frame of base 50, thereby defining a central area into which the strip tube holder 52 are inserted, for example a flange having a 1.27 mm width. Further, base 50 can be configured to act as actual test wells or to hold individual micro tubes as illustrated in FIG. 3.

The test wells can be provided in a number of configurations. In one aspect, the test wells are PCR wells or deep wells. Typically, when the test wells are integrated into the base the microplate is designed as a single use disposable unit, although they can be washed to remove hazardous material or recover valuable material. In another aspect, the array of microwells is configured as recesses to hold tube inserts. In one optional aspect, the recesses are open-bottom, i.e. through holes for the incorporation of filters or extraction columns. In another aspect the microwells can be opaque, translucent or transparent to enhance the detection. The microwells can be provided in a wide variety of shapes depending on the particular application. Non-limiting examples of well shapes include cylindrical shape, tapered conical shape, round bottom shape, or incorporate special features that enhance a specific process and the like.

The orientation of microwells in the array can be arranged in any suitable spacing. However, most often the microwells are uniformly spaced along a grid pattern. The pitch can be varied and is most often 18, 9, 4.5, 2.25, 1.125 or 0.50625 mm.

Some embodiments of the present invention provide an enhanced microplate which provides additional columns and/or rows which can be used to increase the number of active unknown samples while still providing wells for holding standard or reference materials. In some embodiments, one column of the array of microwells is designated for standards or references, while the remaining columns are designated for unknown samples. Thus, an enhanced plate is provided which increases the storage capacity for unknown samples while still providing microwells for required standards, controls, and other reference materials.

The enhanced microplates of the present invention have the same footprint as conventional microplates, and as specified by the SBS. This feature facilitates using existing equipment without requiring structural modifications to either the microplate or equipment used to analyze samples within the microplate. In some embodiments, all that is required for effective use of the enhanced microplate is to program the software running the equipment to recognize the change in location and number of wells. However, PCR thermal cyclers also have a thermal block which keeps the wells uniformly heated via the Peltier heaters. Thus, in some embodiments a complimentary block heater is formed to adapt the enhanced microplates to be inserted into the PCR thermal cycler units.

One method of using an enhanced microplate in accordance with the present invention includes introducing a plurality of fluid samples into the plurality of microwells of the enhanced microplate. The plurality of fluid samples is then treated in accordance with known procedures (e.g. immunoassays, radioimmunoassay, enzymatic assays, colorimetric assays, solid phase extraction, ELIZA, tissue and cell culture, PCR, and the like). Following treatment of the fluid samples, the remaining fluid is subjected to an appropriate test to measure a desired property from which valuable information is obtained.

In some embodiments, the plurality of fluid samples includes a plurality of unknown samples, a plurality of reference samples, and plurality of standard samples. Non-limiting examples of analysis that may be performed using the enhanced microplates include Molecular Genetics assays such as Factor V, Prothrombin, molecular sequencing and fragment analysis assays such as fragile X and Huntington's disease, infectious disease assays such as HIV quantization, radioimmmuno assays such as vitamin D 1, 25, ELIZA, and other immuno assays such as Heliobacter Pylori, and flow cytometry assays such as CD4/CD8.

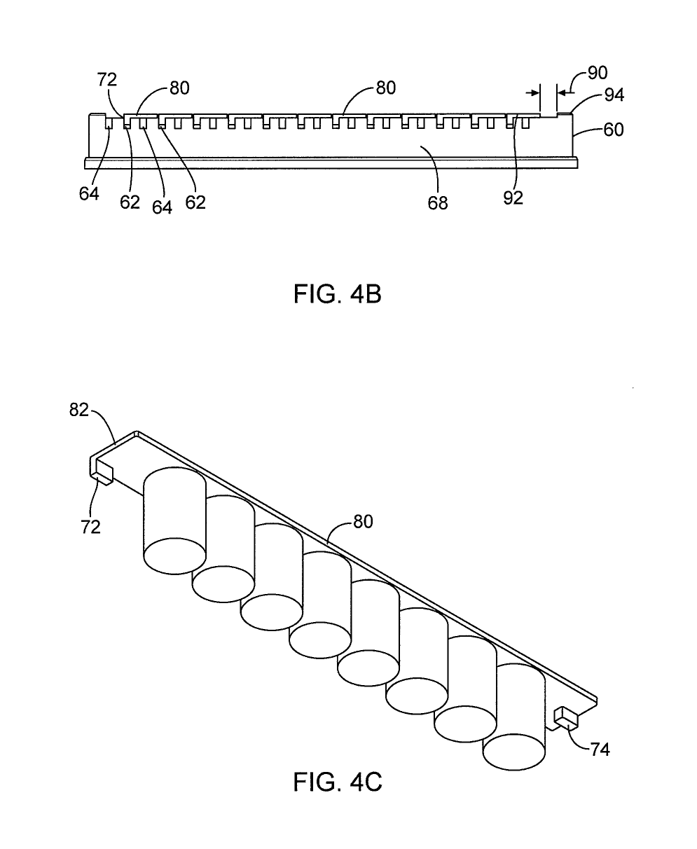

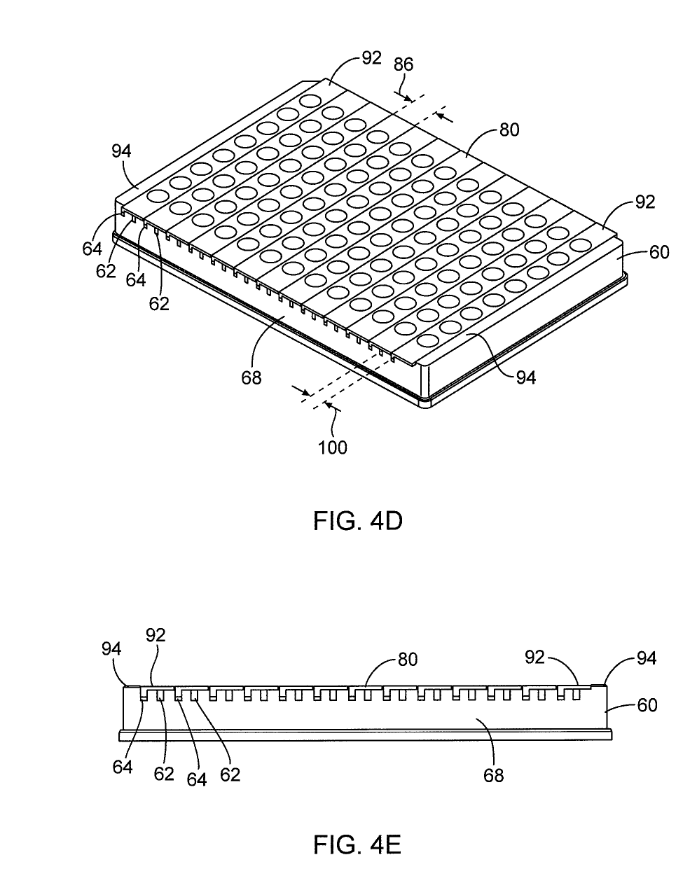

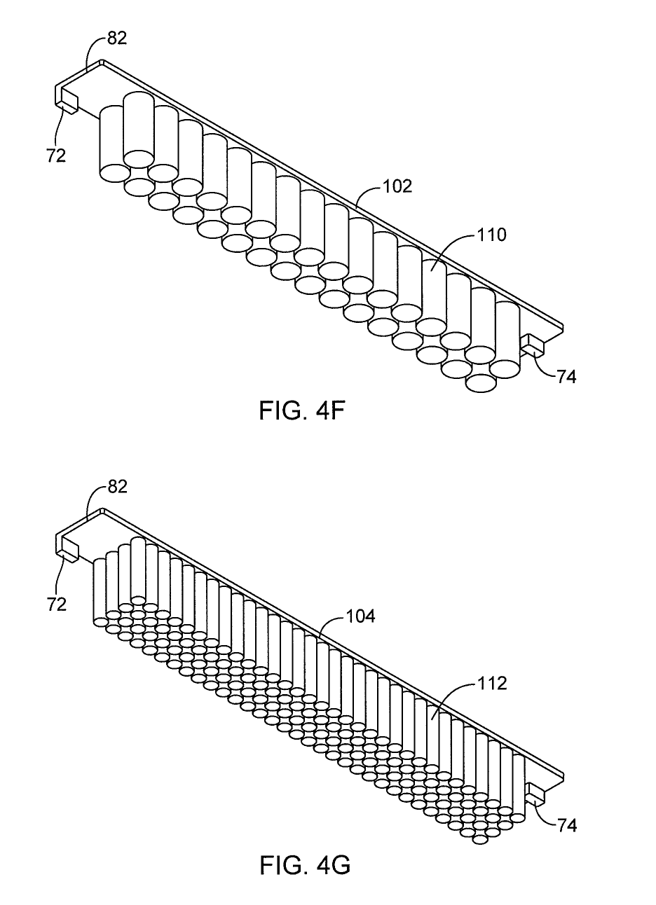

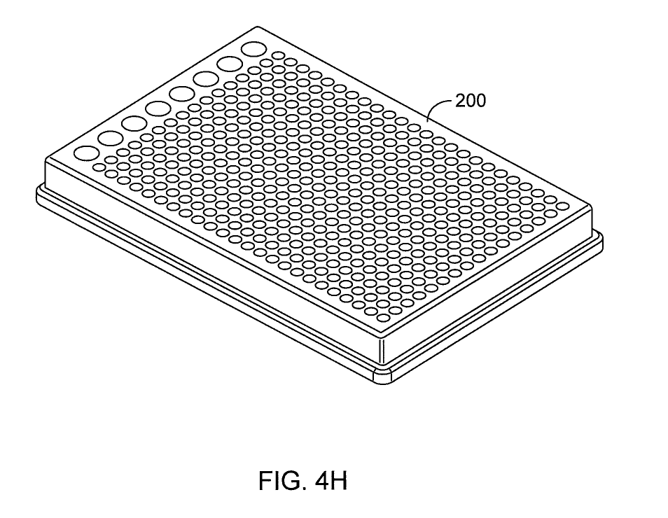

Referring now to FIGS. 4A-4C, in some embodiments base 60 comprises features for selectively receiving and retaining sample well strips 80. Examples of such features include one or more gaps, tabs, notches, hooks, wedges, snaps, spacers, and/or other spacing and retaining mechanisms. For example, in some embodiments, a first set of notches 62 for receiving a first tab 72 of a sample well strip 80 in a first position. First set of notches 62 are positioned along a first rail 68 of base 60 and spaced such that when the first tab 72 of a plurality of sample well strips 80 is engaged with the respective first notches 62, a 96-well plate configuration is achieved, as shown in FIGS. 4A and 4B.

With reference to FIG. 4C, first tab 72 is positioned on a first end 82 of strip 80 at an off-center location. The off-center position of tab 72, when engaged with notch 62, shifts the position of strips 80 inwardly towards the center of the base 60 thereby leaving a gap 90 between outer strips 92 and base flanges 94. A complimentary set of notches (not shown) is provided on the opposite rail whereby to receive a second tab 74 of sample well strip 80 when first tab 72 is engaged within first notch 62. In some embodiments, a complimentary set of notches and second tabs 74 are configured such that the second tab 74 latches or catches within the complimentary set of notches to maintain the position of strip 80 within its respective notches.

With continued reference to FIGS. 4A-4C, base 60 further comprises a second set of notches 64 for receiving first tab 72 of sample well strip 80 in a second position. In particular, second set of notches 64 are positioned along first rail 68 of base 60 and spaced such that when the first tab 72 of a plurality of sample well strips 80 is engaged with the respective second notches 64, a 104-well plate configuration is achieved, as shown in FIGS. 4D and 4E.

Thus, in some embodiments, the notch and tab system of base 60 follows the general formula where engaging the first tab 72 with first set of notches 62 provides a plate configuration determined by (x wells)*(y sample well strips), i.e., (8 wells)*(12 sample wells strips)=96-well plate configuration. Further, the notch and tab system of base 60 follows the general formula where engaging the first tab 72 with the second set of notches 64 provides a plate configuration determined by (x wells)*((y+1) sample well strips)), i.e., (8 wells)*((12+1) sample wells strips)=104-well plate configuration. Still further, in some embodiments the sample well strip capacity of base 60 follows the general formula where a first limit of base 60 is equal to x well strips, and a second limit of base 60 is equal to x+1 well strips. For example, as discussed above, a first well strip limit of base 60 is 12 wells, while a second strip limit is 12+1=13 well strips.

One having skill in the art will appreciate that the width 86 of the sample well strip may be varied by basing the width of the strip on a fractional measurement of base 60. For example, with reference to FIGS. 4A and 4D width 86 of strip 80 is selected to be 1/12 of base 60 when strip 80 is fitted within first set of notches 62, and 1/13 of base 60 when strip 80 is fitted within the second set of notches 64. Alternatively, in some embodiments the width 86 of a sample well strip is selected to be ⅕ of base 60, such that base 60 may be fitted with five strips. Still further, in some embodiments width 86 of a sample well strip is selected to be a fraction of base 60, non-limiting examples of which may include 1/20, 1/10, ¼, ⅓, ½, ⅝, ⅞, 15/16 of base 60. Thus, in some embodiments a user selectively fits base 60 with a variety of sample well strips to fill base 60 to 100% capacity. In other embodiments, a user selectively fits base 60 with a variety of sample well strips to fill base 60 to less than 100% capacity. In some embodiments, a sample well strip is provided having a width 86 that is approximately equal to base 60, such that when base 60 is fitted with the sample well strip, base 60 is filled to approximately 100% capacity. Thus, the combined sample well strip and base 60 provide a mono-plate.

With reference to FIG. 4C, the off-centered position of first tab 72, when engaged with second notch 64, shifts the position of strips 80 outwardly towards flanges 94 thereby filling gap 90, shown in FIGS. 4A and 4B, above. Again, a complimentary set of notches (not shown) is provided on the opposite rail whereby to receive second tab 74 of sample well strip 80 when first tab 72 is engaged with second notch 64.

In some embodiments, a distance 100 between first notch 62 and second notch 64 is equal to one half of width of a sample well strip 80. For example, where the width of a sample well strip 80 is 9 mm, distance 100 is equal to 4.5 mm, or 0.5 (width of strip). Thus, when first tab 72 of strip 80 is moved outwardly from first notch 62 to second notch 64, the distal gap 90 is filled thereby leaving a proximal gap equal to 9 mm, or the width of the thirteenth sample well strip 80, as shown in FIGS. 4D and 4E.

With reference to FIGS. 4F and 4G, the notch and tab system of base 60 is further compatible with sample well strips 102 and 104, respectively. Sample well strip 102 comprises 32 sample wells 110, such that when first tab 72 is engaged with first notch 62, a 384-well plate configuration is achieved. Further, when the first tab 72 of sample well strip 102 is engaged with second notch 64, a 416-well plate configuration is achieved.

Sample well strip 104 comprises 64 sample wells 112, such that when first tab 72 of sample well strip 104 is engaged with first notch 62 of base 60, a 1536-well plate configuration is achieved. Further, when first tab 72 of sample well strip 104 is engaged with second notch 64 of plate 60, a 1664-well plate configuration is achieved. The sample well capacity of base 60 is therefore expanded or contracted based on which notch first tab 72 is engaged. Thus, the notch and tab system of base 60 provides a dynamic microwell plate while adhering to the dimensional restrictions and standards set by the SBS.

One having skill in the art will appreciate that the sample well strips of the present invention may be modified to include any number of sample wells, as may be desired. Additionally, as discussed above, the sample well strips of the present invention may be modified to comprise any width as may be desired. Thus, the notch and tab system of the present invention provides a dynamic microwell plate that is customizable to achieve any desired arrangement and/or configuration.

In some embodiments, the notch and tab system of base 60 enables a user to mix and match a variety of sample well strips to achieve any desired plate configuration. For example, in some embodiments a single second notch 64 is fitted with a sample well strip 80 having 8-wells, while the remaining second notches 64 are fitted with sample well strips 102 having 32-wells. As such, a plate configuration is provided comprising 384-wells, plus an additional 8-wells. In other embodiments, a single second notch 64 is fitted with a sample well strip 80 having 8-wells, another single second notch 64 is fitted with a sample well strip 102 having 32-wells, and the remaining eleven second notches 64 are fitted with sample well strips 104 having 64-wells per well strip. Thus, a plate configuration is provided comprising a total of 744-wells. Still further, in some embodiments an integral microwell plate 200 is provided comprising a mixed and matched combination of wells, as shown in FIG. 4H. Thus, the enhanced microplate of the present invention provides for unique combinations of wells and microwell plate configurations.

Further, in some embodiments a sample well strip comprising a single reservoir well is fitted in base 60. Still further, in some embodiments a sample well strip comprising a single reservoir well is fitted in a first portion of base 60, while the remaining portion of base 60 is fitted with additional sample well strips. Additional embodiments provide mix-and-match configurations with a base comprising only a single set of notches. Therefore, one having skill in the art will appreciate that any number of mix-and-match combinations may be implemented to provide a microwell plate having any desired microwell configuration.

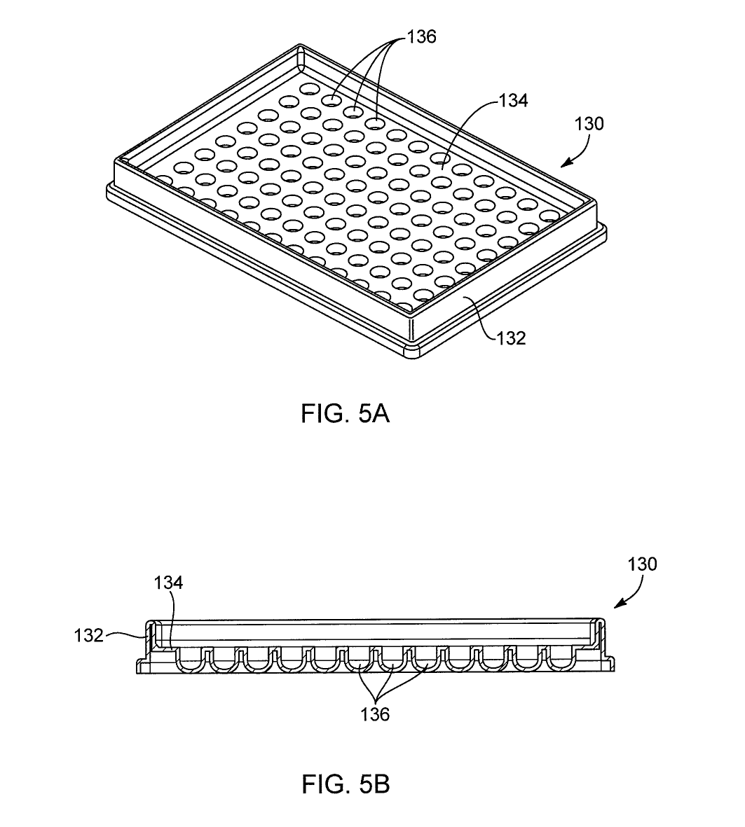

Referring now to FIGS. 5A and 5B, a discrete volume reservoir plate 130 is shown. In some embodiments, plate 130 comprises an extended sidewall 132 forming a boundary or perimeter around a recessed surface 134. Recessed surface 134 comprises a plurality of wells 136, each well having a discrete volume which is known to a user of the plate 130. In some embodiments, a sample or reagent is added to the plurality of wells 136 by pouring the sample or reagent onto recessed surface 134.

The initial sample volume is determined by multiplying the discrete volume of each well 136 by the total number of wells. In some embodiments, the initial sample volume is calculated to include a small amount of waste, thereby providing for errors in pipetting or other errors in preparing the sample or reagent. Once added to the recessed surface 134, the sample is then screeded across wells 136 thereby causing even distribution of the sample across all wells 136. Sidewalls 132 facilitate screeding of the sample by retaining the sample within the bounds of plate 130. Once the sample has been evenly distributed to the plurality of wells 136, sample or reagent is drawn from the wells and used as determined by the user. Thus, discrete volume plate 130 provides for accurate distribution of a sample or reagent while limiting dead volumes of sample or reagent, as is common to standard sample reservoirs.

In some embodiments, plate 130 comprises a plurality of wells 136, wherein the discrete volume of each well, or a group of wells differs from the discrete volume of other wells located within the plate 130. In this way, wells or groups of wells may be designated to hold more or less volumes of a reagent, as may be desired by a user. Thus, plurality of wells 136 is not limited to include equal discrete volumes.

### EXAMPLES

Unless otherwise specified, all dimensions are applicable at 20 degrees C. (68 degrees F.). Compensation may be made for measurements made at other temperatures. ASME YI4.5M-1994, dimensioning and tolerancing are also used throughout these examples. The base footprint is as defined by SBS ANSI/SBS 1-2004, height dimensions are defined by SBS ANSI/SBS 2-2004, height can range from 0.15 to 150 mm, and the bottom flange is defined by SBS ANSI/SBS 3-2004. However, these are not limited to flange or flangeless designs.

### 28-Well Microplate

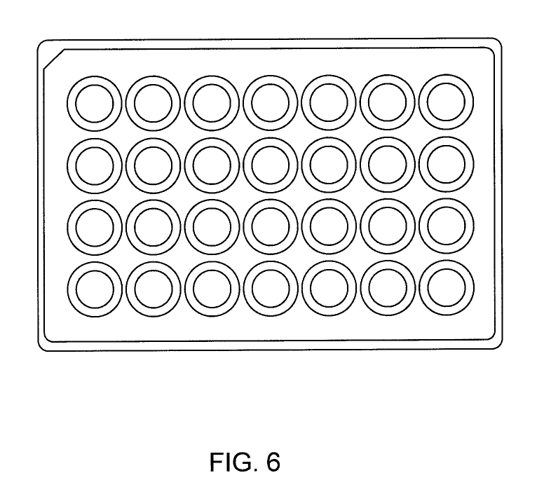

FIG. 6 shows the layout having wells in a 28 well microplate arranged as four rows by seven columns. The distance between the left outside edge of the plate and the center of the first column of wells is 9.88 mm (0.3890 inches). The left edge of the part will be defined as the two 12.7 mm areas (as measured from the corners) as specified in SBS-1. Each following column shall be an additional 18 mm (0.7087 inches) in distance from the left outside edge of the plate. The distance between the top outside edge of the plate and the center of the first row of wells is 15.74 mm (0.6197 inches). The top edge of the part will be defined as the two 12.7 mm areas (as measured from the corners) as specified in SBS 1. Each following row shall be an additional 18 mm (0.7087 inches) in distance from the top outside edge of the plate. The positional tolerance of the well centers will be specified using so called “True Position”. The center of each well will be within a 0.70 mm (0.0276 inches) diameter of the specified location. This tolerance will apply at “RFS” (regardless of feature size).

### 104-Well Microplate

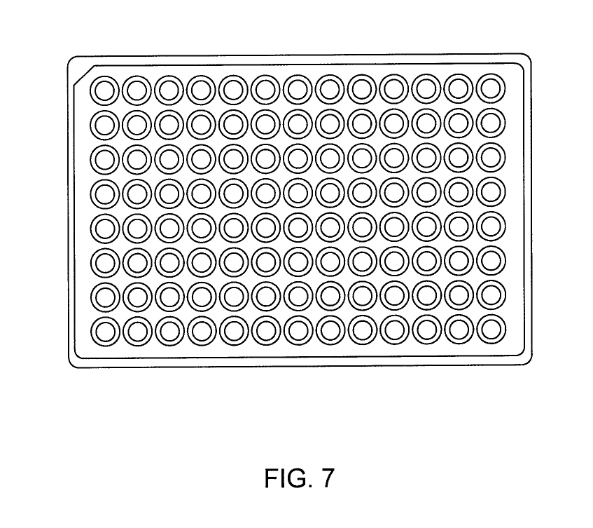

FIG. 7 shows wells in a 104 well microplate arranged as eight rows by thirteen columns. The distance between the left outside edge of the plate and the center of the first column of wells is 9.88 mm (0.3890 inches). The left edge of the part is defined as the two 12.7-mm areas (as measured from the corners) as specified in SBS-1. Each following column shall be an additional 9.0 mm (0.3543 inches) in distance from the left outside edge of the plate. The distance between the top outside edge of the plate and the center of the first row of wells shall be 11.24 mm (0.4425 inches). The top edge of the part is defined as the two 12.7 mm areas (as measured from the corners). Each following row shall be an additional 9 mm (0.3543 inches) in distance from the top outside edge of the plate. The positional tolerance of the well centers is specified using so called “True Position”. The center of each well is within a 0.70 mm (0.0276 inches) diameter of the specified location. This tolerance will apply at “RFS” (regardless of feature size).

### 416 Well Microplate

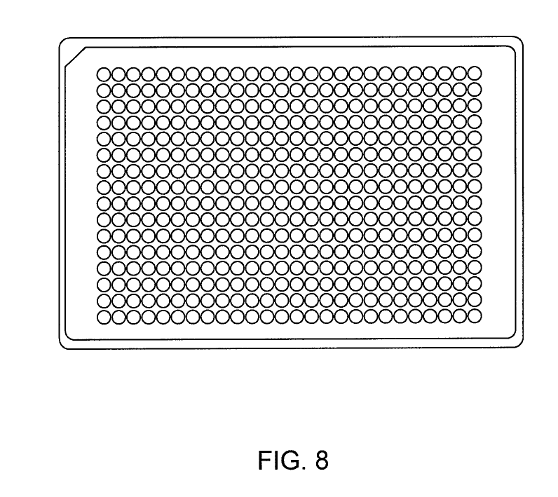

FIG. 8 shows wells in a 384 well microplate should be arranged as sixteen rows by twenty-six columns. The distance between the left outside edge of the plate and the center of the first column of wells shall be 7.63 mm (0.3004 inches). The left edge of the part will be defined as the two 12.7 mm areas (as measured from the corners) as specified in SBS-1. Each following column shall be an additional 4.5 mm (0.1772 inches) in distance from the left outside edge of the plate. The distance between the top outside edge of the plate and the center of the first row of wells shall be 8.99 mm (0.3539 inches). The top edge of the part will be defined as the two 12.7 mm areas (as measured from the corners) as specified in SBS-1. Each following row shall be an additional 4.5 mm (0.1772 inches) in distance from the top outside edge of the plate. The positional tolerance of the well centers will be specified using so called “True Position”. The center of each well will be within a 0.70 mm (0.0276 inches) diameter of the specified location. This tolerance will apply at “RFS” (regardless of feature size).

### 1664 Well Microplate

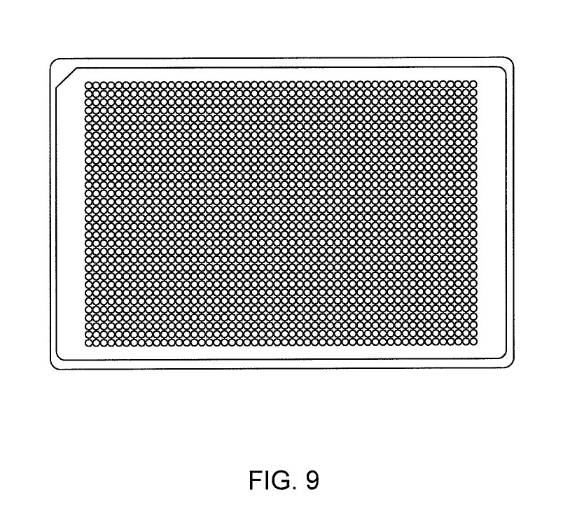

FIG. 9 shows wells in a 1664 well microplate should be arranged as thirty-two rows by fifty-two columns. The distance between the left outside edge of the plate and the center of the first column of wells shall be 6.38 mm (0.2512 inches). The left edge of the part will be defined as the two 12.7 mm areas (as measured from the corners) as specified in SBS-1. Each following column shall be an additional 2.25 mm (0.0886 inches) in distance from the left outside edge of the plate. The distance between the top outside edge of the plate and the center of the first row of wells shall be 7.865 mm (0.3096 inches). The top edge of the part will be defined as the two 12.7 mm areas (as measured from the corners) as specified in SBS-1. Each following row shall be an additional 2.25 mm (0.0886 inches) in distance from the top outside edge of the plate. The positional tolerance of the well centers will be specified using so called “True Position”. The center of each well will be within a 0.50 mm (0.0197 inches) diameter of the specified location. This tolerance will apply at “RFS” (regardless of feature size).

### Example 1

Chemical and molecular screening library store the samples in 96 well formats. When it comes to analysis some samples are removed to accommodate standards and controls. These “extra” samples are run on a different plate. In this instance the mother daughter plate mapping is lost and sample analysis testing becomes staggered. If a 104 plate is used then all analytes can be run simultaneously with mother daughter plate maps unbroken.

### Example 2

Molecular genetics assays are comprised of two processes, DNA extraction and analysis. Both process use instrumentation capable with 96 well microplates. In order to analyze 96 wells 88 samples must be extracted. Thus the extractor is running at 91.7% through put. If the extractor process 96 samples then only 88 can be run due to the incorporation of standards controls and occasional repeats. Thus the analyzer is operating only at 91.7% throughput.

### Example 3

Automated radioimmunoassays have additional tubes to determine total radioactive count and count due to nonspecific binding. These factors plus the standard curve are used to quantify the specimen's analyte. If specimen standards and controls are processed in a 96 well format two options exist for automating. The first is to reduce the sample number to accommodate the later addition of total count and nonspecific binding tubes and down steam processing is undisturbed. The second is to add additional plates to accommodate the total count and nonspecific binding tubes. This option increases the time spent on downstream process such as centrifugation which will require multiple spins due to microplate centrifuges only hold 2 heavy micro plates. The 104 plate takes advantage of both options in that it can accommodate the 96 sample processing, total count and non specific binding tubes as well as downstream processing of reduced samples due to all tubes being constrained within the microplate format.

The foregoing detailed description describes the invention with reference to specific representative embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

What is claimed is:

1. A device for selectively retaining a position of an item, the device comprising:
a well having an opening for receiving an item, the well further having a retaining surface; and
a retention member positioned adjacent to the well, a portion of the retention member overlapping a portion of the opening of the well, wherein the retention member contacts a portion of the item thereby biasing the item against the retaining surface of the well.

2. The device of claim 1, wherein the retention device comprises an o-ring.

3. The device of claim 1, further comprising a plurality of adjacently positioned wells.

4. The device of claim 3, wherein each of the plurality of adjacently positioned wells comprises an opening, and wherein the retention member is centrally positioned within the plurality of adjacently positioned wells such that a portion of the retention member overlaps a portion of the opening of each adjacently positioned well.

5. The device of claim 3, wherein each of the plurality of adjacently positioned wells comprises an opening, and wherein the retention member comprises a plurality of retention members, and wherein at least one retention member overlaps a portion of the opening of an adjacently positioned well opening.

6. The device of claim 1, wherein the retention member comprises a portion of the retaining surface.

7. The device of claim 1, wherein the well comprises a recess defined by a plurality of pillars.

8. The device of claim 7, wherein the retention member is coupled to at least one of the plurality of pillars.

9. The device of claim 1, wherein the well comprises a microwell plate.

10. The device of claim 1, wherein the retention member provides an interference fit.

11. A dynamic microplate device, comprising:
a base having a first set of notches and a second set of notches; and
a sample well strip having a tab for selective positioning of the sample well strip in at least one of the first and second set of notches, wherein selective positioning of the tab in the first set of notches achieves a first sample plate configuration, and selective positioning of the tab in the second set of notches achieves a second sample plate configuration.

12. The device of claim 11, wherein the sample well strip comprises a plurality of sample well strips, and wherein the first set of notches accommodates a first limit of sample well strips, and wherein the second set of notches accommodates a second limit of sample well strips, wherein the first limit of sample well strips is not equal to the second limit of sample well strips.

13. The device of claim 12, wherein the first limit is x well strips, and the second limit is x+/well strips.

14. The device of claim 11, further comprising means for selectively securing the sample well strip within the base.

15. The device of claim 11, wherein the first sample plate configuration is (x wells)*(y sample well strips), and the second sample plate configuration is (x wells)*((y+1) sample well strips)).

16. The device of claim 11, further comprising a distance interposed between the first set of notches and the second set of notches, wherein the distance is approximately equal to one-half of a width of the sample well strip.

17. The device of claim 11, wherein the sample well strip comprises a width based on a fraction of the base.

18. The device of claim 12, wherein each of the sample well strips comprise a number of sample wells, and wherein the number of sample wells varies between each of the sample well strips.

19. A reservoir plate, comprising:
a sidewall forming a perimeter boundary;
a recessed surface located within the perimeter boundary; and
a plurality of wells disposed within the recessed surface, each of the wells comprising a discrete volume.

20. The reservoir plate of claim 20, wherein the plurality of wells comprise a plurality of discrete volumes.
